(19) United States
(12) Patent Application Publication
(10) Pub. No.: US 2010/0190128 A1
(43) Pub. Date: Jul. 29, 2010

(54) ORTHODONTIC ARCH WIRE AND METHOD FOR USING THE SAME

(76) Inventor: Arthur L. Wool, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/690,202

(22) Filed: Jan. 20, 2010

Related U.S. Application Data
(60) Provisional application No. 61/146,779, filed on Jan. 23, 2009.

(51) Int. Cl. A61C 7/20; A61C 7/36

(52) U.S. Cl. 433/20; 433/24

(57) ABSTRACT

A reverse curve archwire includes a generally smoothly curved U-shaped metal wire having a curved central anterior segment including a mesial center line of the U-shaped metal wire and a pair of posterior segments extending from ends of the anterior segment. Each posterior segment has a reverse Curve of Spee of a predetermined radius when relaxed. A pair of connecting members is attached to the archwire, each connecting member being provided on a respective side of the mesial center line.

### BACKGROUND OF THE INVENTION

Reverse curve archwires or arches are designed to introduce a flattening effect to a dental arch that is excessive in its curve. A typical reverse curve arch 100 is shown in FIG. 8. The natural curve of dental arches is slight and is known as the Curve of Spee. If excessive, depending upon upper or lower arch, it may accentuate a deep or open bite to the occlusion. Reverse curve arches treat this condition by attempting to bow the arch and its dental elements in a manner reverse to the existing curve. Thus, a reverse curve arch is made of a generally smoothly curved U-shaped metal wire having a curved central anterior segment and a pair of posterior segments extending from the ends of the anterior segment, each posterior segment having a reverse Curve of Spee of a predetermined radius when relaxed. The posterior sections can also be “toed in” as is known in the art.

I have found these reverse curve arches to introduce a distal driving effort to the dentition. This occurs when the arch is in place in all teeth and the last tooth on each side is affixed with either a buccal tube or a combination bracket/tube that will be the last element holding the reverse curve in place. As shown in FIG. 1, if the posterior end 1′ of the reverse curve arch were not in the tube 2 (see the broken lines in FIG. 1), the end 1′ of the reverse curve arch would lie (passively) far above the tube 2. By placing the end 1 of the reverse curve arch in the tube 2 (see the solid lines in FIG. 1), the curve has been brought down but presses upwardly on the tube 2, especially at point 3. There is an inclined plane of force created with not only an upward component, but also a force vector 4 backwards out of the tube 2. Thus, the bow present in the reverse curve arch (upper jaw) exerts a pressure on the end of the last holding fixture and tooth. This upward (gingival) pressure is thwarted in its effort to elevate the tooth and the force of the arch at its most distant point in the last fixture presents the conditions of an inclined plane in which there is a distal component of the force introduced into the arch by its restriction in elevation (or depression in the lower arch) by the last dental fixture. This attempt of the arch to creep and urge itself backwards and out of the last fixture creates a slight retractive force upon the anterior teeth. This is beneficial in cases wherein there exists an upper or lower dental protrusion at the start of orthodontic treatment.

Many orthodontic cases, however, require substantial retraction due to the initial protrusion present, requiring a good deal of anterior tooth retraction, made even greater when dental elements must be extracted in order to successfully treat the case. Such cases are aided by the slight retraction introduced by a reverse curve arch, but this force is not sufficient to treat the cases in an expeditious manner. Supplemental force is needed to increase the retraction required.

### SUMMARY OF THE INVENTION

A reverse curve archwire includes a generally smoothly curved U-shaped metal wire having a curved central anterior segment including a mesial center line of the U-shaped metal wire and a pair of posterior segments extending from ends of the anterior segment. Each posterior segment has a reverse Curve of Spee of a predetermined radius when relaxed. A pair of connecting members is attached to the archwire, each connecting member being provided on a respective side of the mesial center line.

The reverse curve archwire is used by connecting elastics to the connecting members of an upper or lower reverse curve archwire and anchoring the elastics to distal portions of end sections of lower or upper orthodontic appliances, thereby effecting a distal supplemental force to that already induced by the reverse curve archwire.

### BRIEF DESCRIPTION OF THE DRAWINGS

FIG. 1 is a schematic view showing a posterior end of a reverse curve arch in a buccal tube.

FIG. 2 is a perspective view showing one embodiment of a reverse curve archwire according to the present invention.

FIG. 3 is an enlarged view of the circled portion including the hook 15 in FIG. 2.

FIG. 4 is a perspective view showing another embodiment of a reverse curve archwire according to the present invention.

FIG. 5 is an enlarged view of the circled portion including the post 15′ in FIG. 4.

FIG. 6 is a perspective view showing another embodiment of a reverse curve archwire according to the present invention.

FIG. 7 is an enlarged view of the circled portion including the post 15″ in FIG. 6.

FIG. 8 is a perspective view showing a typical reverse curve arch.

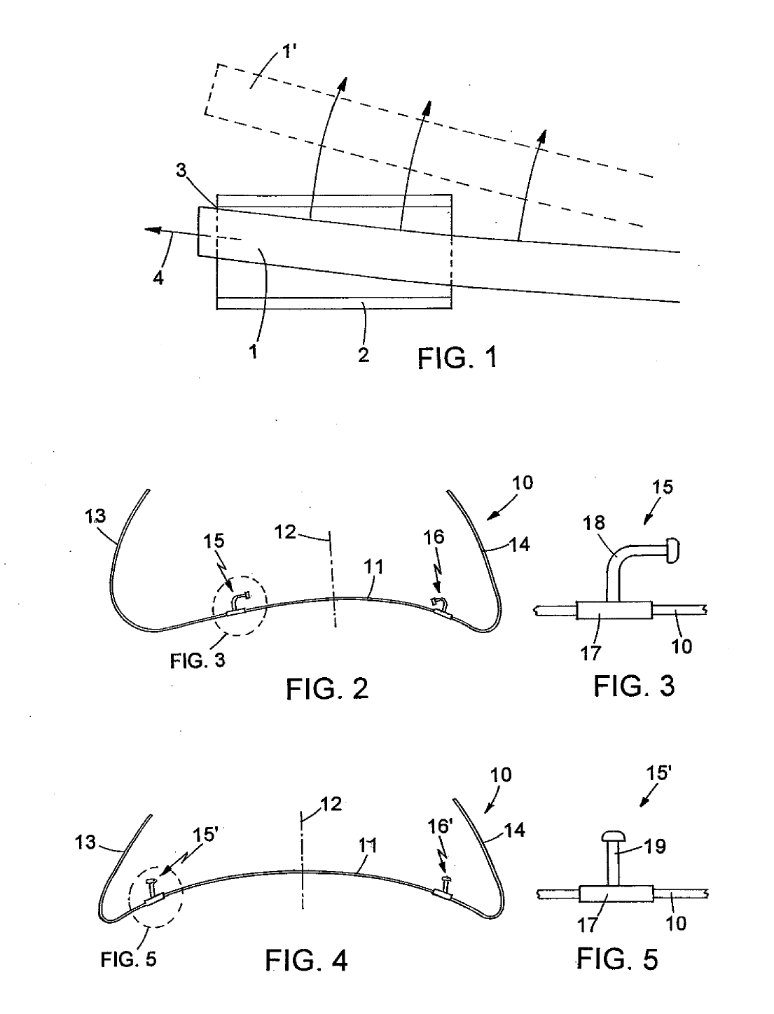

### DETAILED DESCRIPTION OF THE PREFERRED EMBODIMENTS

The addition of retractive force to a reverse curve arch is beneficial and can be accomplished with elastic force directed along the reverse curve arch to accomplish the distal movement of the dentition. The hook-up of these elastics require a reverse curve arch of different design than those heretofore designed and made for the orthodontic profession. There is a need for a hook or post as an integral part of the arch, a design change that has not been offered before.

Thus, a method for using the reverse curve archwire to achieve additional treatment benefits to the patient, should protrusive elements of the anterior teeth be present in either jaw, is to augment and supplement the slight retractive force present in a seated reverse curve archwire by affixing hooks or posts to the reverse curve archwire, enabling the placement of latex elastics to span from the hooks or posts to the posterior ends of either arch, adding a slight cumulative distal force to the reverse curve archwire, helping the correction of the anterior protrusion.

A reverse curve archwire according to the present invention is shown in FIGS. 2 and 3 and includes a generally smoothly curved U-shaped metal wire 10 having a curved central anterior segment 11 including a mesial center line 12 of the U-shaped metal wire and a pair of posterior segments 13, 14 extending from ends of the anterior segment 11. Each posterior segment 13, 14 has a reverse Curve of Spee of a predetermined radius when relaxed. A pair of connecting members 15, 16 is attached to the archwire 10, each connecting member being provided on a respective side of the mesial center line 12. The connecting members can be any shape that will allow an elastic to be connected, e.g., each connecting member a hook or post.

The phrase “smoothly curved” used herein means that the archwire does not include a T-loop such as that described in U.S. Pat. No. 5,131,843, the contents of which are incorporated herein in their entireties.

In the embodiment of FIG. 2, each posterior segment 13, 14 is toed in with a curve having another predetermined radius as is known in the art.

The metal wire can be made of any material known in the art to be useful for archwires, e.g., superelastic NiTi, thermal NiTi or stainless steel. The archwire can have a round or rectangular cross-section.

In the embodiment of FIGS. 2 and 3, the connecting members 15, 16 are hooks.

FIGS. 4 and 5 show another embodiment in which a rectangular archwire includes two posts 15′, 16′.

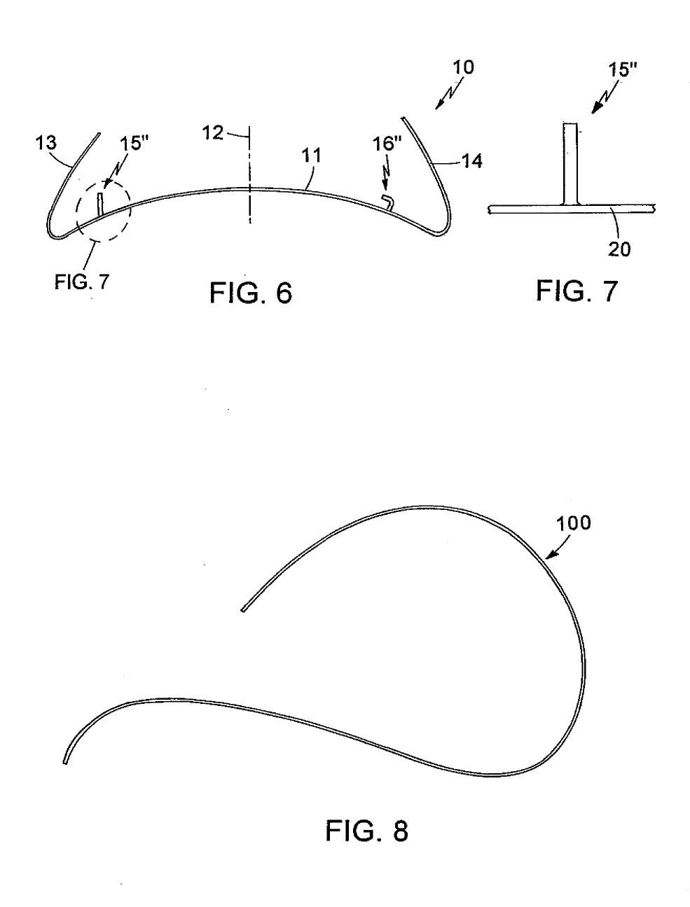

FIGS. 6 and 7 show another embodiment in which a round archwire includes a post 15″ and a hook 16″. Of course any combination of connecting members of any size and shape can be used.

In the embodiments of FIGS. 2-5, the connecting members 15, 16 or 15′, 16′ are composed of hook members 18 or post members 19 provided on a thin walled steel tube 17 of about 1.5 to 2 mm in length that is crimped into place on the U-shaped metal wire 10. It is generally not possible to directly solder hooks or posts to arches made of either superelastic NiTi or thermal NiTi. Therefore, the use of a crimpable tube 17 is especially useful for arches made of either superelastic NiTi or thermal NiTi. The hook or post can be connected to the crimpable tube 17 in any manner known in the art, e.g., by soldering.

In the embodiment of FIGS. 6 and 7, the connecting members 15″, 16″ are posts 20 (or hooks) attached directly to the U-shaped metal wire 10. In the case of arches made of superelastic NiTi or thermal NiTi, the hook or post can be laser welded. In the case of arches made of stainless steel, any of the foregoing attachment methods can be used, in addition to soldering.

The archwire of the resent invention is used by placing both its posterior ends into receiving tubes (buccal) that have been affixed to molar bands or brackets on either or both upper and lower appliances of a patient. The bow of the archwire should be opposite to that of the bow of the dental elements in each arch. The balance of the upper archwire should be seated in all the brackets present in the upper jaw, the anterior segment of the archwire requiring lowering to effect the seating in the anterior brackets present on the anterior teeth. The balance of the lower archwire, if utilized, should be seated in all the brackets present in the lower jaw, the anterior segment of the archwire requiring raising to effect seating in the anterior brackets present on the anterior teeth.

The anterior seating of the archwire, requiring lowering to seat the anterior brackets of the upper jaw and raising to seat the anterior brackets of the lower jaw will subject the anterior teeth of the respective jaws to intrusive force. This force will induce tooth movements that will tend to ameliorate deep bite conditions of the anterior teeth in which the over-closure of the upper anterior teeth in respect to the lower, when the jaws are brought into occlusion, is known to the profession as a deep bite as well as induce distal force upon the anterior teeth by means of distal force created when the archwires are placed in the upper or lower buccal tubes.

I claim:

1. A reverse curve archwire comprising a generally smoothly curved U-shaped metal wire having a curved central anterior segment including a mesial center line of the U-shaped metal wire and a pair of posterior segments extending from ends of the anterior segment, each posterior segment having a reverse Curve of Spee of a predetermined radius when relaxed, and a pair of connecting members attached to the archwire, each connecting member being provided on a respective side of the mesial center line.

2. The reverse curve archwire according to claim 1, wherein the connecting members are hooks and/or posts.

3. The reverse curve archwire according to claim 1, wherein each posterior segment is toed in with a curve having another predetermined radius.

4. The reverse curve archwire according to claim 1, wherein generally smoothly curved U-shaped metal wire is made of superelastic NiTi or thermal NiTi.

5. The reverse curve archwire according to claim 1, wherein the generally smoothly curved U-shaped metal wire is made of stainless steel.

6. A method for using the reverse curve archwire according to claim 1, comprising connecting elastics to the connecting members of an upper or lower reverse curve archwire and anchoring the elastics to distal portions of end sections of lower or upper orthodontic appliances, thereby effecting a distal supplemental force to that already induced by the reverse curve archwire.
